(19) United States
(12) Patent Application Publication
(10) Pub. No.: US 2008/0162241 A1
(43) Pub. Date: Jul. 3, 2008

(54) METHOD AND SYSTEM FOR MATCHING AND MONITORING FREIGHT LOADS

(75) Inventor: Ernest Bias Betancourt, Lascasses, TN (US)

Correspondence Address: BANNER & WITCOFF, LTD., 1100 13th STREET, N.W., SUITE 1200, WASHINGTON, DC, 20005-4051, US

(73) Assignee: BETAZONE, INC., Brentwood, TN (US)

(21) Appl. No.: 11/963,093

(22) Filed: Dec. 21, 2007

Related U.S. Application Data
(63) Continuation of application No. 10/178,503, filed on Jun. 24, 2002.
(60) Provisional application No. 60/300,703, filed on Jun. 25, 2001.

(51) Int. Cl. G06Q 10/00

(52) U.S. Cl. 705/8

(57) ABSTRACT

A method and system for matching a load tendered by a participating freight transportation company with an available truck of another freight transportation company for transporting that load, and then providing for monitoring of the matched load throughout transport, is implemented through a computer network. Each participating freight transportation company employs a similar computer system for managing its freight transportation operations, with each such computer system being operably connected to a central server through the network so as to allow for a seamless exchange of information and data between the computer systems.

### CROSS REFERENCES TO RELATED APPLICATIONS

This application claims priority to U.S. patent application Ser. No. 10/178,503 filed Jun. 24, 2002 and entitled “Method and System for Matching and Monitoring Freight Loads,” which claims priority to U.S. Provisional Application Ser. No. 60/300,703 filed Jun. 25, 2001, both of which are incorporated herein by reference.

### BACKGROUND OF THE INVENTION

The present invention relates to a method and system for matching a load tendered by a participating freight transportation company with an available truck of another freight transportation company for transporting that load, a method and system that further provides for monitoring of the matched load throughout transport and is preferably implemented through a computer network.

In shipping and transporting consumer goods and other products, upon receipt of an order for transportation of a load, a particular freight transportation or “trucking” company needs to identify and dispatch one of its trucks to transport the load. However, in many instances, the trucking company simply does not have an available truck to dispatch. Since the trucking company certainly does not want to decline the order, or indeed may be contractually obligated to fulfill the order, the trucking company will essentially sub-contract transportation of the load, locating and retaining a truck of another tricking company to carry the load. Unfortunately, locating and retaining another truck is often a time-consuming process that requires numerous telephone calls and inquiries until a suitable truck is located. In response, some attempts to develop an automated or computer-based system to assist in “load matching” have been made; however, such systems are generally not designed for integration into existing systems employed by trucking companies to manage their freight transportation operations. Furthermore, such load matching systems are not designed for an exchange of information between trucking companies regarding the status of the load subsequent to the matching process and throughout transport of the load. Specifically, such load matching systems do not adequately provide information from the sub-contracting trucking company back to the contracting trucking company, such as information concerning dispatch, loading at origination, arrival and unloading at destination.

It is therefore an object of the present invention to provide a method and system for matching and monitoring freight loads that can be integrated into existing systems for managing freight transportation operations.

It is a further object of the present invention to provide a method and system for matching and monitoring freight loads that allows for a seamless exchange of information and data among systems employed by trucking companies to manage their freight transportation operations.

It is still a further object of the present invention to provide a method and system for matching and monitoring freight loads that allows for monitoring of a freight load subsequent to the matching process and throughout transport, providing status information from the subcontracting trucking company back to the contracting trucking company.

These and other objects and advantages of the present invention will become apparent upon a reading of the following description.

### SUMMARY OF THE INVENTION

The present invention is a method and system for matching a load tendered by a participating freight transportation company with an available truck of another freight transportation company for transporting that load, a method and system that further provides for monitoring of the matched load throughout transport and is preferably implemented through a computer network.

A first trucking company, Customer A. employs a computer system for managing its freight transportation operations, e.g., a computer system running the Innovative Enterprise Software® developed and distributed Innovative Computing Corporation of Oklahoma City, Okla. This computer system is operably connected to a central server (preferably maintained by a third party administrator) through some form of public or private network. Customer A needs to rapidly locate and retain a truck for transportation of a particular load. Through its computer system for managing its freight transportation operations, Customer A designates that a truck is needed to transport the particular load, and that information is communicated through the network to the central server.

A second trucking company, Customer B, employs a similar computer system for managing freight transportation operations, a computer system that is also operably connected to the central server described above through some form of public or private network. Customer B has one or more available trucks, but has no loads for these trucks to carry. Through its computer system for managing its freight transportation operations, Customer B designates that one or more trucks are available, and that information is communicated through the network to the central server.

At the central server, as the information identifying a particular available truck is received, the central server carries out a matching process in an attempt to match the truck to a load for which transport is sought. The matching process examines the availability of the truck, compares locations (origins and destinations) and equipment requirements, and also filters out any “mismatches” in customer preferences. Once a list of “matches” is generated by the central server, the central server communicates this information back through the network to computer system for managing freight transportation operations maintained by Customer B.

A representative of Customer B can view potential matches for a particular tendered truck and then select whether to accept a particular load through an appropriate keystroke. The computer system communicates this acceptance through the network to the central server which, in turn, communicates the acceptance to the computer system for managing freight transportation operations maintained by Customer A.

Once this load matching process is complete, Customer A and Customer B can remain in contact through the central server for communications regarding the status of the load. Specifically, the central server facilitates exchange of information from the sub-contracting trucking company back to the contracting trucking company, such as information concerning dispatch, loading at origination, arrival and unloading at destination.

The method and system of the present invention therefore allows for efficient and automatic matching of a particular load of one trucking company to a particular truck of another trucking company through a central server, and further provides for subsequent monitoring of the load throughout transport, i.e., the exchange of information from the sub-contracting trucking company back to the contracting trucking company about the load. In this regard, the method and system of the present invention is preferably integrated into existing systems for managing freight transportation operations so as to allow for a seamless exchange of information and data among systems employed by trucking companies to manage their freight transportation operations at all relevant times.

### DESCRIPTION OF THE FIGURES

FIG. 1 is a representative example of a load data screen in a preferred implementation of the method and system of the present invention, a load data screen that is displayed on a conventional personal computer operably connected to an overall computer system employed by a trucking company for managing freight transportation operations;

FIG. 2 is a representative example of a load confirmation screen in the preferred implementation of the method and system of the present invention;

FIG. 3 is a representative example of a truck data screen in the preferred implementation of the method and system of the present invention;

FIG. 4 is a representative example of a truck confirmation screen in the preferred implementation of the method and system of the present invention;

FIG. 5 is a representative example of another data screen in the preferred implementation of the method and system of the present invention;

FIG. 6 is a representative example of another data screen in the preferred implementation of the method and system of the present invention; and

FIG. 7 is a schematic representation of the computer network associated with the preferred embodiment of the method and system of the present invention.

### DETAILED DESCRIPTION OF THE INVENTION

The present invention is a method and system for matching a load tendered by a participating freight transportation company with an available truck of another freight transportation company for transporting that load, a method and system that further provides for monitoring of the matched load throughout transport and is preferably implemented through a computer network so as to allow for a seamless exchange of information and data among systems employed by trucking companies to manage their freight transportation operations at all relevant times.

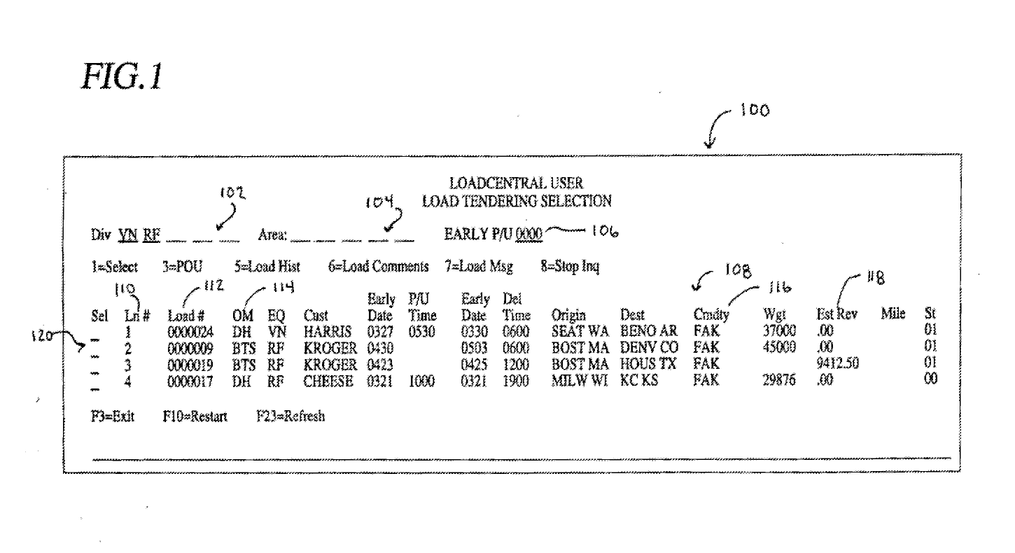

FIG. 1 is a representative example of a load data screen 100 in a preferred implementation of the method and system of the present invention, a load data screen 100 that is displayed on a conventional personal computer operably connected to an overall computer system employed by a trucking company for managing freight transportation operations. In this regard, the overall system provides not only for the “load matching” functionality described below, but also manages such tasks as the receipt of orders, the dispatching of trucks based on those orders, tracking of loads in transit, and billing. For example, the Innovative Computing Corporation of Oklahoma City, Okla. (a wholly owned subsidiary of the assignee of the present application) markets such a software product under the mark Innovative Enterprise Software®. The method and system of the present invention is specifically adapted for use with this software product.

Referring still to FIG. 1, Customer A is a trucking company. Customer A is in the process of dispatching trucks based on received orders. Recognizing that there is not an available truck to carry a particular load, Customer A needs to rapidly locate and retain a truck for transportation of the particular load. Through its system for managing freight transportation operations, a representative of Customer A can access load data screen 100. Then, through this load data screen 100, Customer A can tender the particular load. Specifically, Customer A tenders a load by inputting various information and data identifying the load. In most instances, and as illustrated in FIG. 1, this information will have already been entered into the customer's system for managing freight transportation operations upon receipt of a load order. Thus, no further data entry is required. Rather, Customer A need only designate that the particular load is to be tendered in accordance with the method and system of the present invention.

As illustrated in FIG. 1, in the preferred implementation of the method and system of the present invention, in the upper portion of the load data screen 100, there are data entry fields associated with the designation “Div” (as generally indicated by reference numeral 102) and the designation “Area” (as generally indicated by reference numeral 104). By inputting the appropriate codes associated with a load division and/on a geographic pick-up area, Customer A can filter the displayed load data, as is further described below. Furthermore, in this preferred embodiment, there is another data entry field 106 labeled “EARLY P/U” which allows for an entry of a date. Only those loads available for pick-up on or after the inputted date are displayed.

In the central portion of the load data screen 100, data associated with the loads available for tendering is preferably displayed in a table 108. In the preferred embodiment illustrated in FIG. 1, the following information is displayed in the table 108 for each load:

TABLE A

| | |
|---|---|
| Ln# | Line Number |
| Load # | Load Number |
| OM | Message Code |
| EQ | Equipment |
| Cust | Customer |
| Early P/U Date | Early Pick-up Date |
| Earl P/U Time | Early Pick-up Time |
| Early Delivery Date | Early Delivery Date |
| Early Delivery Time | Early Delivery Time |
| Origin | Origin (City State) |
| Destination | Destination (City State) |
| Cmdty | Commodity |
| Wgt | Weight |
| Est Rev | Estimated Revenue |
| Mile | Miles |
| St | Stops |

Most of the tabular load data is self-explanatory (i.e., Equipment, Customer, Early PickUp Date and Time, Early Delivery Date and Time, Origin, Destination, Weight, Miles, and Stops), particularly to one experienced in the trucking industry. Aside from these common data fields, the first two data columns are respectively labeled “Ln#” and “Load#.” The “Ln#” column 110 is merely informational, identifying the line number of a particular load in the table 108. The “Load#” column 112 identifies the load number as assigned by the customer's system for managing freight transportation operations. The next column is labeled “OM” and refers to order message codes. Specifically, the codes contained in the “OM” column 114 are system codes for conveying specific messages about a particular load.

In the latter portion of the table 108, there is a column 116 labeled “Cmdty” for the type of commodity. In the example of FIG. 1, each load is designated “FAK” or “Freight of All Kinds.” Of final note, also in the latter portion of the table 108, the “Est Rev” column 116 provides the estimated revenue associated with a particular load.

Associated with each row of load data, there is a data entry field, generally indicated by reference numeral 120, that allows the user to select an action that is to be taken with respect to a particular load. Specifically, in the preferred embodiment described herein and illustrated in FIG. 1, certain numerical values input in the data entry field 120 result in specific actions being taken with respect to a particular load, naively:

TABLE B

| | |
|---|---|
| 1 | Select |
| | [For Load Tendering] |
| 3 | POU |
| | [Partial Order Update] |
| 5 | Load Hist |
| | [Load/Order History] |
| 6 | Load Comments |
| | [Load/Order Comments] |
| 7 | Load Msg |
| | [Load/Order Message] |
| 8 | Stop lnq |
| | [Stop Off Information] |

Referring to the specific actions outlined in Table B, the function of primary importance to the method and system of the present invention is the “Select” function associated with entry of the numerical value “1” in data entry field 120. This indicates that the selected load is to be tendered in accordance with the method and system of the present invention, as will be described in further detail below. The other functions outlined in Table B allow the user to access other information about a selected load as maintained in the customer's system for managing freight transportation operations.

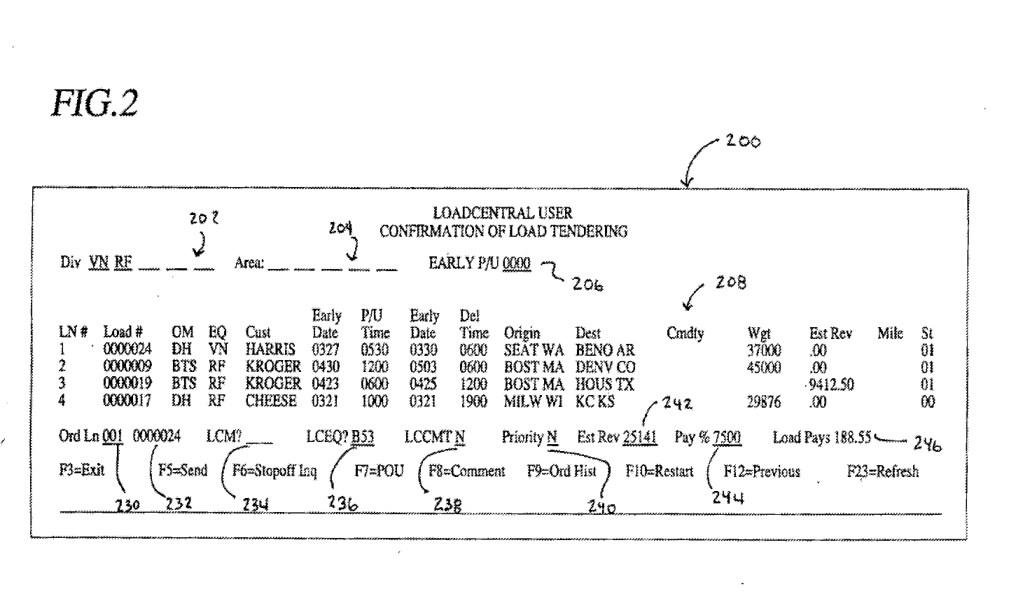

After one or more loads have been designated for tendering by entry of the numerical value “1” in the associated data entry field 120, Customer A so indicates by striking ENTER or trough another similar keystroke, and upon confirmation (as described with reference to FIG. 2, the information and data identifying the tendered loads will be transmitted through the computer network to a central server. The central server is preferably maintained by a third party administrator and stores and maintains all information and data for all participating trucking companies, thus allowing for a controlled, yet seamless, exchange of information and data between trucking companies.

As a final note with respect to FIG. 1, additional functionality is preferably provided trough use of certain F-keys on the computer keyboard. In this preferred embodiment, F3 causes the user to exit the load data screen 100, F10 restarts the data entry process, and F23 refreshes the table 108 to reflect any data changes.

FIG. 2 is a representative example of a load confirmation screen 200 in the preferred implementation of the method and system of the present invention. As illustrated in FIG. 2, once one or more loads have been designated for tendering (as described above with reference to FIG. 1), a confirmation of the selected loads is displayed for review by Customer A. Specifically, and similar to FIG. 1, the load division 202, geographic pick-up area 204, and early pick-up date 206 are preferably displayed along the top portion of the load confirmation screen 200. In this regard, only those loads meeting the load division 202, geographic pick-up area 204, and early pick-up date 206 criteria are displayed.

In the central portion of the load confirmation screen 200, data associated with the loads confirmed for tendering is displayed in a table 208. In the preferred embodiment illustrated in FIG. 2, the following information is displayed in the table 208 for each load:

TABLE C

| | |
|---|---|
| Ln# | Line Number |
| Load # | Load Number |
| OM | Message Code |
| EQ | Equipment |
| Cust | Customer |
| Early P/U Date | Early Pick-upDate |
| Early P/U Time | Early Pick-up-Time |
| Early Delivery Date | Early Delivery Date |
| Early Delivery Time | Early Delivery Time |
| Origin | Origin (City State) |
| Destination | Destination (City State) |
| Cmdty | Commodity |
| Wgt | Weight |
| Est Rev | Estimated Revenue |
| Mile | Miles |
| St | Stops |

The information displayed in the table 208 is the same information displayed in the table 108 of the load data screen 100 of FIG. 1. Of course, in the table 208 of FIG. 2, only loads that have been submitted for tendering in accordance with the method and system of the present invention are displayed.

In the lower portion of the load confirmation screen 200, there is a data entry field 230 which allows a user to enter a line number for a particular load displayed in the table 208. Once a line number is so entered, the load number will be displayed, as indicated by reference numeral 232. The user must then enter additional details about each load for the tendering process. First, the data field labeled “LCM” (as generally indicated by reference numeral 234) allows the user to enter a message code reflecting a specific message or instruction associated with the selected load. Indeed, it is contemplated and preferred that a library of message codes be accessible such that the user can simply select an appropriate message code from the library. Another data field is labeled “LCEQ” (as generally indicated by reference numeral 236) and allows the user to enter an equipment code reflecting specific equipment requirements associated with the selected load, at least to the extent that such equipment requirements have not already been identified. Another data field is labeled “LCCMT” (as generally indicated by reference numeral 238) and allows the user to choose whether or not to send order comments contained in its system for managing freight transportation operations to the central server where they can be viewed by other participating parties as part of the load matching process. In this regard, although not illustrated in the accompanying Figures, if the user enters “Y” in data field 238 to signify a willingness to send order comments, it is contemplated and preferred that a window will be displayed to allow the user to choose which specific order comments to send. Another data field is labeled “Priority” (as generally indicated by reference numeral 240) and allows the user to choose designate a priority load, e.g., a load has special requirements with respect to sending status information back to the submitting user (Customer A).

The final data fields associated with the selected load to be tendered relate to revenue. First, there is a data field is labeled “Est Rev” (as generally indicated by reference numeral 242) that allows the estimated revenue for the selected load to be updated. Another data field is labeled “Pay %” (as generally indicated by reference numeral 244) and allows the user to specify the amount that will be paid on a load. For example, as illustrated in FIG. 2, Customer A has stated that it will pay 75% of estimated revenues to a carrier accepting shipment of Load # 000024. Based on a simple mathematical calculation, multiplication of the estimated revenue by the pay percentage, the “Load Pays” amount (as generally indicated by reference numeral 246) is displayed.

After the requisite data has been entered for a selected load, in this preferred embodiment, the selected load is tendered and transmitted through the computer network to the central server mentioned above through striking the F5 key on the computer keyboard.

As a final note with respect to FIG. 2, additional functionality is preferably provided through use of other F-keys on the computer keyboard. In this preferred embodiment, and as with FIG. 1, F3 causes the user to exit, 1710 restarts the data entry process, and F23 refreshes the table 208 to reflect any data changes. Additionally, F6 provides the user with stop-off information for the selected load, F7 provides the user with a partial order update, F8 provides the user with an listing of all order comments and further identifies those which have been designated for transmission to the central server for the load matching process, F9 provides the order history, and F12 returns the user to the prior data screen.

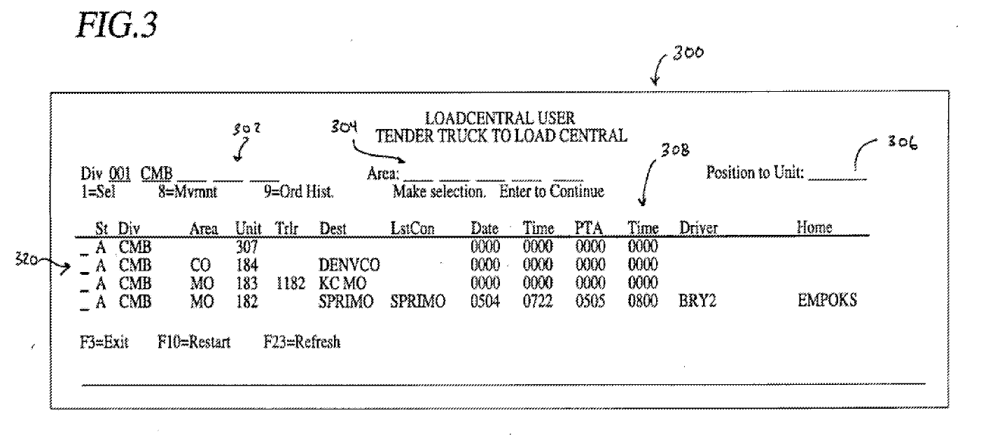

FIG. 3 is a representative example of a truck data screen 300 in the preferred implementation of the method and system of the present invention. The truck data screen 300 is also displayed on a conventional personal computer operably connected to the computer network, but for Customer B. Customer B is another trucking company that has one or more available trucks, but has no loads for these trucks to carry. Through its system for managing freight transportation operations, a representative of Customer B can access the truck data screen 300. Then, through this truck data screen 300, Customer B can tender a particular truck. Specifically, Customer B tenders a truck by inputting various information and data identifying the truck and its availability. In most instances, and as illustrated in FIG. 3, this information will have already been entered into the customer's system for managing freight transportation operations. Thus, no further data entry is required. Rather, Customer B need only designate that the particular truck is available and is to be tendered in accordance with the method and system of the present invention.

As illustrated in FIG. 3, in the preferred implementation of the method and system of the present invention, in the upper portion of the truck data screen 300, there are data entry fields associated with the designation “Div” (as generally indicated by reference numeral 302) and the designation “Area” (as generally indicated by reference numeral 304). By inputting the appropriate codes associated with a truck division and/on a geographic pick-up area, Customer B can filter the displayed truck data, as is further described below. Furthermore, in this preferred embodiment, there is another data entry field 306 labeled “Position to Unit” which allows the user to select for display to the data associated with a particular truck (or unit) rather than scrolling through the table 308 described below.

In the central portion of the truck data screen 300, data associated with the trucks available for tendering is preferably displayed in a table 308. In the preferred embodiment illustrated in FIG. 3, the following information is displayed in the table 308 for each truck:

TABLE D

| | |
|---|---|
| St | Status |
| Div | Division |
| Area | Area |
| Unit | Truck Identification |
| Trlr | Trailer Identification |
| Dest | Destination |
| LstCon | Last Contact (City State) |
| Date | Last Contact Date |
| Time | Last Contact Time |
| PTA | Projected Date Available |
| Time | Proiected Time Available |
| Driver | Driver Code |
| Home | Driver Home (City State |

Most of the tabular load data is self-explanatory, particularly to one experienced in the trucking industry. Of particular interest to the method and system of the present invention is the first data column 310 which is labeled “St” for status. This data column 310 is important in that it identifies the current status of each displayed truck as monitored by the customer's system for managing freight transportation operations. In this preferred implementation of the method and system of the present invention, the status is generally indicated by the character “A” for available or “D” dispatched to area in data column 310. Additionally, it is contemplated and preferred that there may be an additional character following the status code in data column 310 to provide additional information, for example:

TABLE E

| | |
|---|---|
| P | Truck is pre-planned on another load. |
| C | Truck is pre-planned and driver is |
| | committed to load. |
| 2 | There are two drivers on the truck. |
| T | The second driver is a trainee. |

Associated with each row of truck data, there is a data entry field, generally indicated by reference numeral 320, that allows the user to select an action that is to be taken with respect to a particular truck. Specifically, in the preferred embodiment illustrated in FIG. 3, certain numerical values input in the data entry field 320 result in specific actions being taken with respect to a particular truck, namely:

TABLE F

| | |
|---|---|
| 1 | Select |
| | [For Tendering Truck] |
| 8 | Mvmnt |
| | Display Movement] |
| 9 | Ord Hist. |
| | [Order History] |

Referring to the specific actions outlined in Table F, the function of primary importance to the method and system of the present invention is the “Select” function associated with entry of the numerical value “1” in data entry field 320. This indicates that the selected truck is to be tendered in accordance with the method and system of the present invention, as will be described in further detail below. The other functions outlined in Table B allow the user to access other information about a selected truck as maintained in the customer's system for managing freight transportation operations.

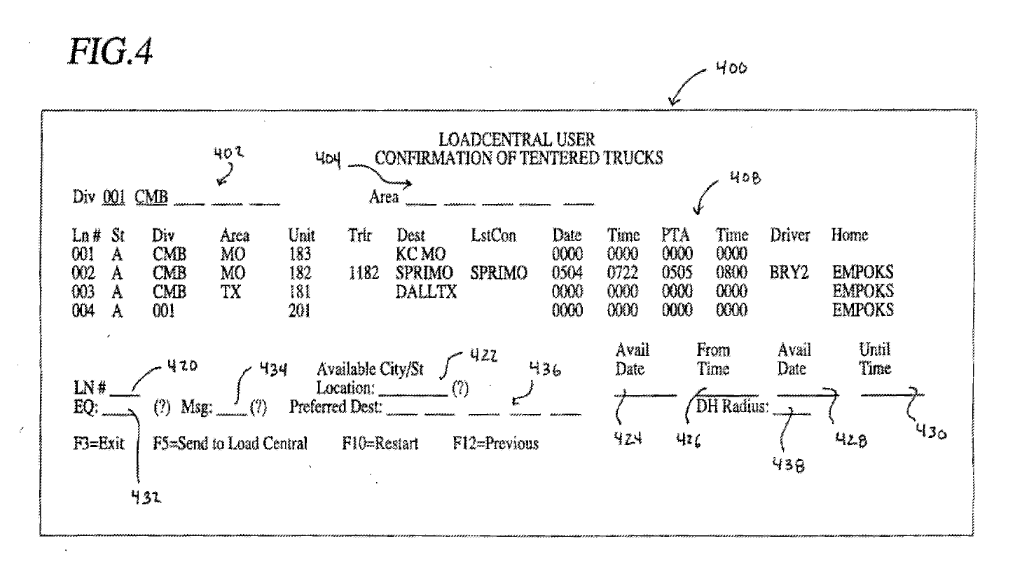

After one or more trucks have been designated for tendering by entry of the numerical value “1” in the associated data entry field 320, Customer B so indicates by striking ENTER or through another similar keystroke, and upon confirmation (as described with reference to FIG. 4), the information and data identifying the tendered trucks will be transmitted through the computer network to a central server.

As a final note with respect to FIG. 3, additional functionality is preferably provided through use of certain F-keys on the computer keyboard. In this preferred embodiment, F3 causes the user to exit the truck data screen 300, F10 restarts the data entry process, and F23 refreshes the table 308 to reflect any data changes.

FIG. 4 is a representative example of a truck confirmation screen 400 in the preferred implementation of the method and system of the present invention. As illustrated in FIG. 4, once one or more trucks have been designated for tendering, a confirmation of the selected trucks is displayed for review by Customer B. Specifically, and similar to FIG. 3, the load division 402 and geographic pick-up area 404 are preferably displayed along the top portion of the truck confirmation screen 400. In this regard, only those loads meeting the load division 402 and geographic pick-up area 404 criteria are displayed.

In the central portion of the truck confirmation screen 400, data associated with the trucks confirmed for tendering is displayed in a table 408. In the preferred embodiment illustrated in FIG. 4, the following information is displayed in table 408 for each truck:

TABLE G

| | |
|---|---|
| Ln# | Line Number |
| St | Status |
| Div | Division |
| Area | Area |
| Unit | Truck Identification |
| Trlr | Trailer Identification |
| Dest | Destination |
| LstCon | Last Contact (City State) |
| Date | Last Contact Date |
| Time | Last Contact Time |
| PTA | Projected Date Available |
| Time | Projected Time Available |
| Driver | Driver Code |
| Home | Driver Home (City State) |

The information displayed in the table 408 is the same information displayed in the table 308 of the truck data screen 300 of FIG. 3. Of course, in the table 408 of FIG. 4, only trucks that have been submitted for tendering in accordance with the method and system of the present invention are displayed.

In the lower portion of the truck confirmation screen 400, there is a data entry field 420 which allows a user to enter a line number for a particular truck displayed in the table 408. Once a line number is so entered, the user must then enter additional details about the truck for the tendering process. First, the data field labeled “Available City/St Location” (as generally indicated by reference numeral 422) allows the user to enter where the truck will be available to take a load for a particular date and time range, information necessary for the matching process of the method and system of the present invention, as is more fully described below. It is contemplated and preferred that a library of location codes be accessible such that the user can simply select an appropriate location code from the library. The next four data fields 424, 426, 428, 430 are used to define the date and time range that the truck will be available to take a load.

Specifically, the first two data fields 424, 426 are respectively labeled “Avail From Date” and “Avail From Time,” thus allowing the user to designate the date and time that the truck will become available. The second two data fields 428, 430 are respectively labeled “Avail Until Date” and “Avail Until Time,” thus allowing the user to designate the date and time that the truck's availability will terminate.

Another data field is labeled “EQ” (as generally indicated by reference numeral 432) and allows the user to enter an equipment code reflecting specific equipment requirements associated with the selected load, at least to the extent that such equipment requirements have not already been identified. Another data field is labeled “Msg” (as generally indicated by reference numeral 434) and allows the user to enter and send any message code that pertains to the particular truck.

The next series of data entry fields is labeled “Preferred Dest” (as generally indicated by reference numeral 436) and allows the user to enter up to five preferred destinations for the particular truck.

The final data entry field is labeled “DH Radius” (as generally indicated by reference numeral 438) and allows the user to enter the maximum deadhead radius, i.e., the number of miles the particular truck is willing to travel empty to pick up a particular load.

After the requisite data has been entered for a selected truck, in this preferred embodiment, the selected truck is tendered and transmitted through the computer network to the central server mentioned above through striking the F5 key on the computer keyboard.

As a final note with respect to FIG. 4, additional functionality is preferably provided through use of other F-keys on the computer keyboard. In this preferred embodiment, and as with FIG. 3, F3 causes the user to exit, and F10 restarts the data entry process. Additionally, F12 returns the user to the prior data screen.

At the central server, as the information and data identifying a particular tendered truck is received, the central server carries out a matching process in an attempt to match the tendered truck to a tendered load. In this regard, the matching process examines the availability of the truck, compares locations (origins and destinations) and equipment requirements, and also filters out any “mismatches” in customer preferences. Once a list of “matches” is generated by the central server through the matching process, this information is communicated back to Customer B. With respect to the lists of matches, it is contemplated and preferred that the matches could be grouped and reported based on the Customer B's relationship with other trucking companies. For example, matches with “preferred partners” of the Customer B might be displayed first.

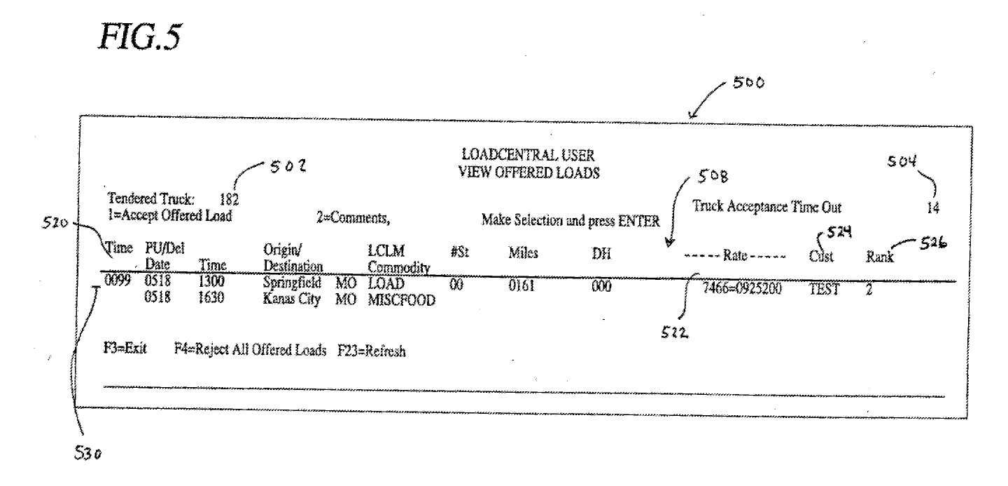

FIG. 5 is a representative example of another data screen 500 in the preferred implementation of the method and system of the present invention. As illustrated in FIG. 5, displayed for Customer B are potential matches for a particular tendered truck. Customer B can view these matches, and then select whether to accept a particular load through an appropriate keystroke. Specifically, in the upper portion of the data screen 500, the tendered truck is identified, as generally indicated by reference numeral 502. Furthermore, a “Truck Acceptance Time Out” value is displayed, as generally indicated by reference numeral 504. This value indicates how much time that has been allotted for the identified trick to be matched.

In the central portion of the data screen 500, data associated with the loads matched with the identified truck are preferably displayed in a table 508. Although the exemplary data screen 500 shows only one matched load in the table 508, it is contemplated that multiple loads could be matched to a particular truck without departing from the spirit and scope of the present invention.

In any event, in the preferred embodiment illustrated in FIG. 5, the following information is displayed in the table 508 for each matched load:

TABLE H

| | |
|---|---|
| Time | Time for Acceptance |
| PU Date | Pick-up Date |
| PU Time | Pick-up Time |
| Del Date | Delivery Date |
| Del Time | Delivery Tune |
| Origin | Origin |
| Destination | Destination |
| LCLM | Load Message Code |
| Commodity | Commodity |
| #St | Number of Stops |
| Miles | Miles |
| DH | Deadhead Miles |
| Rate | Rate |
| Cust | Customer Identification |
| Rank | Rank |

Most of the tabular load data is self-explanatory and has been described more fully above, but a few data fields merits further discussion. First, the data column labeled “Time” (as generally indicated by reference numeral 520) displays the number of minutes that Customer B has to make the decision as to whether to accept or reject a load. If a decision is not made in the time allotted, the load is re-submitted to the central server to re-initiate the matching process.

In the latter portion of the table 508, the data column labeled “Rate” (as generally indicated by reference numeral 522) provides rate and revenue information. Specifically, in this preferred embodiment, the first four characters indicate the offered rate per mile, e.g., $0.7466 per mile. The final seven characters indicate the pay percentage that Customer A indicated it was willing to pay for transport of the identified load, e.g., 92.52%.

The final two data columns identify the customer who tendered the load. The first of these two data columns is labeled “Cust” (as generally indicated by reference numeral 524) and displays a customer identification code. The second of the two data columns is labeled “Rank” (as generally indicated by reference numeral 526) and displays the rank that Customer B (the carrier tendering the truck) has previously assigned Customer A (the carver tendering the particular load). In this regard, as mentioned above, it is contemplated and preferred that matches could be grouped and reported based on the Customer B's relationship with other trucking companies. For example, matches could be displayed in a ranked order.

Associated with each row of load data in the data screen 500 of FIG. 5, there is a data entry field, generally indicated by reference numeral 530, that allows the user to select an action that is to be taken with respect to a particular load. Specifically, in the preferred embodiment illustrated in FIG. 5, certain numerical values input in the data entry field 530 result in specific actions being taken with respect to a particular load, namely:

TABLE I

| | |
|---|---|
| 1 | Accept Offered Load |
| 2 | Comments |

Referring to the specific actions outlined in Table I, the function of primary importance to the method and system of the present invention is the “Accept Offered Load” function associated with entry of the numerical value “1” in data entry field 530. This indicates that the selected load is accepted for transport by the identified truck. The other function listed in Table I is the “Comments” function associated with entry of the numerical value “2” in data entry field 530, which allows the user to view comments associated with the selected load.

After a load has been designated for acceptance by entry of the numerical value “1” in the 20 associated data entry field 530, Customer B so indicates by striking ENTER or through another similar keystroke. Acceptance of a particular load is communicated back to the central server, which, in turn, communicates the acceptance to the customer who tendered the load. Furthermore, all other displayed loads are rejected and returned to the matching process.

As a final note with respect to FIG. 5, additional functionality is preferably provided through use of certain F-keys on the computer keyboard. In this preferred embodiment, F3 causes the user to exit the data screen 500, F4 causes a rejection of all offered loads, and F23 refreshes the table 508 to reflect any data changes.

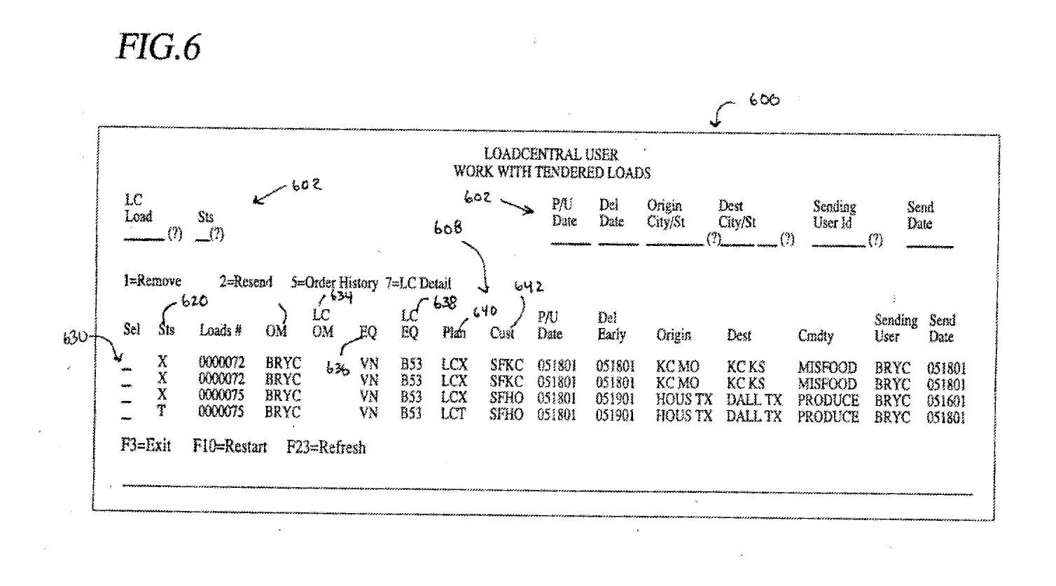

Finally, FIG. 6 is a representative example of a data screen 600 in the preferred implementation of the method and system of the present invention which can be viewed by Customer A to determine which, if any, tendered loads have been accepted by another trucking company for transportation of the load. As shown in the central portion of the data screen 600 of FIG. 6, there is a table 608 displaying tendered loads and their respective status. In the upper portion of the data screen 600 of FIG. 6, there is a series of data entry fields that allow the user to filter which loads are to be displayed in the table 608_Specifically, identifying data may be entered into the following data entry fields (generally and collectively indicated by referenced numeral 602) to filter the displayed loads:

TABLE J

| | |
|---|---|
| LC Load | Load Identification No. |
| Sts | Status |
| P/U Date | Pick-up Date |
| Del Date | Delivery Date |
| Origin City/St | Origin (City State |
| Dest City/St | Destination (City State) |
| Sending User Id | Identification of User |
| | Tendering Load |
| Send Date | Date of Load |
| | Tendering |

The significance of each of the data entry fields as set forth in Table J is self-explanatory, and most of the data fields have been described more fully above in relation to various other representative data screens.

Referring again to the table 608 of the data screen 600 of FIG. 6, the following information is displayed in table 608 with respect to each accepted load:

TABLE K

| | |
|---|---|
| Sts | Status |
| Load # | Load Number |
| OM | Message Code |
| | [Order] |
| LC OM | Message Code |
| | [Load Tendering Process] |
| EQ | Equipment |
| | [Order] |
| LC EQ | Equipment Code |
| | [Load Tendering Process] |
| Plan | Plan |
| Cast | Customer |
| P/U Date | Pick-up Date |
| Del Early | Early Delivery Date |
| Origin | Origin (City State) |
| Dest | Destination (City State |
| Cmdty | Commodity |
| Sending User | Identification of User |
| | Accepting Load |
| Send Date | Date of Acceptance |

Most of the data columns are self-explanatory and have been described more fully above, but a few data columns merit further discussion. First, the data column labeled “Sts” or “Status” (as generally indicated by reference numeral 620) provides the status of each tendered load.

Specifically, as the following table indicates, letters in the “Sts” data column 620 are used to identify the status of a particular load, for example:

TABLE L

| | |
|---|---|
| P | Pending Load |
| F | Failed |
| | [Not all required information received.] |
| T | Tendered Load |
| | [Load confirmed for matching process] |
| O | Offered |
| | [Load offered to a matched truck.] |
| R | Removed |
| | [Removed by tendering company.] |
| A | Accepted |
| | [Load accepted by matched truck.] |
| X | Expired |
| | [No matches found.] |
| D | Dispatched |
| | [Truck dispatched to transport load.] |
| L | Loaded |
| | [Load picked a by matched truck.] |
| E | Empty |
| | [No current status.] |

Also of note, there are two data columns (respectively indicated by reference numerals 632 and 634) for displaying message codes. The first message data column 632 displays any message codes associated with the original order, as stored in the customer's system for managing freight transportation operation. The second message data column 634 displays any message codes associated with the tendering and matching process described herein. Similarly, there are two data columns (respectively indicated by reference numerals 636 and 638) for displaying equipment codes, a first data column 636 displaying any equipment codes associated with the original order, and a second data column 638 displaying any equipment codes associated with the tendering and matching process described herein.

The data column 640 labeled “Plan” displays a code identifying the accepting carrier, assuming that the load has indeed been accepted. The data column 642 labeled “Cust” displays a code identifying the customer on the original order, as stored in Customer A's system for managing freight transportation operations.

Similar to some of the prior representative screens described above, associated with each row of load data, there is a data entry field, generally indicated by reference numeral 630, that allows the user to select an action that is to be taken with respect to a particular displayed load. Specifically, in the preferred embodiment illustrated in FIG. 6, certain numerical values input in the data entry field 630 result in specific actions being taken with respect to a particular load, namely:

TABLE M

| | |
|---|---|
| 1 | Remove |
| 2 | Resend |
| 5 | Order History |
| 7 | LC Detail |

Referring to the specific actions outlined in Table M, entry of the numerical value “1” in data entry field 630 will result in the removal of the load from the tendering and matching process. Entry of the numerical value “2” in data entry field 630 will result in the re-sending of the load is it has expired. Entry of the numerical value “5” in data entry field 630 causes a display of the order history, and entry of the numerical value “7” in data entry field 630 will result in a display of the historic detail for the load, i.e., the number of times the load has been submitted and/or other administrative details.

As a final note with respect to FIG. 6, additional functionality is preferably provided through use of certain F-keys on the computer keyboard. In this preferred embodiment, F3 causes the user to exit the data screen 600, F10 restarts the data entry process, and F23 refreshes the table 608 to reflect any data changes.

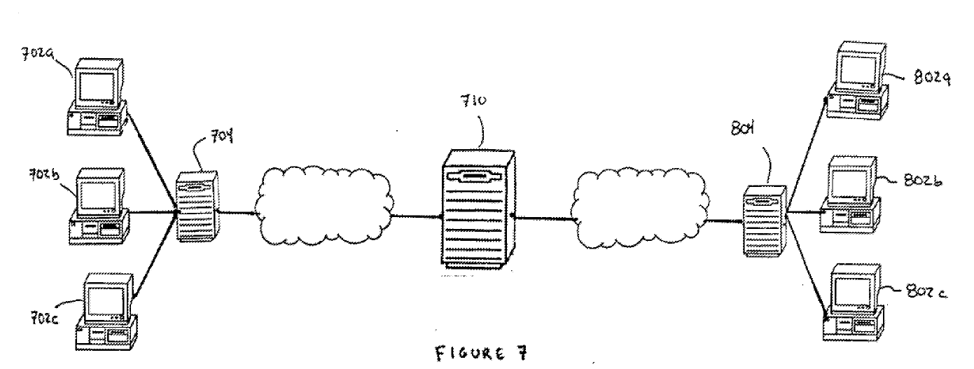

To provide a simple summary of the method and system of the present invention, FIG. 7 is a schematic representation of the computer network associated with a preferred embodiment of the method and system of the present invention. As shown in FIG. 7, a first trucking company has multiple user computers 702a, 702b, 702c, each of which is operably connected to a computer system 704 for managing freight transportation operations, e.g., a computer system running the Innovative Enterprise Software® developed and distributed Innovative Computing Corporation of Oklahoma City, Okla. This computer system is operably connected to the central server 710 described above through some form of public or private network.

For purposes of example, this first trucking company may be considered to be Customer A, a trucking, company needing to rapidly locate and retain a truck for transportation of a particular load. As described above with respect to FIGS. 1 and 2, Customer A designates that the particular load is to be tendered in accordance with the method and system of the present invention, and that information is communicated through the network to the central server 710.

A second trucking company also has multiple user computers 802a, 802b, 802c, each of which is operably connected to a computer system 804 for managing freight transportation operations, e.g., a computer system running the Innovative Enterprise Software® developed and distributed Innovative Computing Corporation of Oklahoma City, Okla. This computer system is also operably connected to the central server 710 described above through some form of public or private network.

For purposes of example, this second trucking company may be considered to be Customer B, a trucking company that has one or more available trucks, but has no loads for these trucks to carry. Therefore, as described above with respect to FIGS. 3 and 4, Customer A designates that the available trucks are to be tendered in accordance with the method and system of the present invention, and that information is communicated through the network to the central server 710.

At the central server, as the information and data identifying a particular tendered truck is received, the central server carries out a matching process in an attempt to match the tendered truck to a tendered load. As described above, the matching process examines the availability of the truck, compares locations (origins and destinations) and equipment requirements, and also filters out any “mismatches” in customer preferences. Once a list of “matches” is generated by the central server through the matching process, this information is communicated back to Customer B. Specifically, the central server 710 communicates through the network and back to the computer system 804 for managing freight transportation operations maintained by Customer B.

As described with reference to FIG. 5, through the user computers 802a, 802b, 802c, a representative of Customer B can view potential matches for a particular tendered truck and then select whether to accept a particular load through an appropriate keystroke. The computer system 804 communicates this acceptance through the network to the central server which, in turn, communicates the acceptance to the computer system 704 for managing freight transportation operations maintained by Customer A, as described with reference to FIG. 6.

The method and system of the present invention therefore allows for efficient matching of a particular load of one trucking company to a particular truck of another trucking company through the central server. Perhaps more importantly, the method and system of the present invention is preferably integrated into existing systems for managing freight transportation operations so as to allow for a seamless exchange of information and data among systems employed by trucking companies to manage their freight transportation operations. In this regard, subsequent to the matching process described above, Customer A can continue to monitor the status of the load that has been tendered and accepted by Customer B. Specifically, the network illustrated in FIG. 7 allows for continued exchange of information between participating trucking companies regarding the status of tendered and matched loads subsequent to the matching process and throughout transport of the load. Customer A can therefore monitor and track Customer B's truck, the truck matched to Customer A's load through communications through the central server 710. In other words, for purposes of monitoring and tracking, Customer B's truck essentially becomes part a virtual fleet of Customer A.

For example, when Customer B's truck picks up a load tendered and matched in accordance with the method and system of the present invention by Customer A, Customer B will post a status change through its computer system 804 for managing freight transportation operations. Customer B's computer system 804 then communicates that status change information through the central server 710 which, in turn, communicates the status change to the computer system 704 for managing freight transportation operations maintained by Customer A for viewing by a representative of Customer A.

As a further refinement, it is also contemplated that Customer A have the option of querying the status of a truck that is carrying a load tendered and matched in accordance with the method and system of the present invention. Specifically, Customer A could request a status update through its computer system 704. That status request would be communicated to the central server 710 which, in turn, would communicate the status request to the computer system 804 maintained by Customer B.

Finally, it is understood that although two trucking companies are illustrated in FIG. 7 for purposes of example, an infinite number of trucking companies could be operably connected to the central server and participate in the method and system of the present invention without departing from the spirit and scope of the present invention.

As should become clear from the above description, to carry out execution of the routines and subroutines of the method and system of the present invention, it is understood that standard programming techniques and languages would be used. With benefit of the description contained herein, such programming is readily accomplished by one of ordinary skill in the art.

Furthermore, it will be obvious to those skilled in the art that other modifications may be made to the invention as described herein without departing from the spirit and scope of the present invention.

What is claimed is:

1. A method for matching an available shipment with an available shipping container, comprising:
receiving, at a central server, information associated with at least one available shipment, the information associated with the at least one available shipment being input by a first freight carrier having a computer system connected to the central server;
receiving, at a central server, information associated with at least one available shipping container, the information associated with the at least one available shipping container being input by a second freight carrier having a computer system connected to the central server;
performing an automated association process at the central server, the automated association process including:
identifying a plurality of matching criteria to be met in determining an association;
assessing the at least one available shipment to identify characteristics of the shipment meeting the matching criteria;
assessing the at least one available shipping container to identify characteristics of the shipping container meeting the matching criteria;
associating the at least one available shipment with the at least one available shipping container based on the characteristics of the shipment and shipping container identified as meeting the matching criteria.

2. The method of claim 1, wherein the identified matching criteria include at least one of shipping container availability, shipment availability, shipment location, shipping container location, shipment destination and shipping container characteristics.

3. The method of claim 1, further including the step of outputting the associated shipment and shipping container.

4. The method of claim 1, further comprising monitoring the shipment, subsequent to the automated association process, via the computer systems connected to the central server, wherein the monitoring is performed by the first freight carrier and the second freight carrier and wherein the step of monitoring is performed subsequent to the step of automatically associating.

5. The method of claim 4, wherein the step of monitoring further includes transmitting a status change.

6. One or more computer-readable media storing computer-executable instructions that, when executed by a computer, perform a method, comprising:
receiving, at a central server, information associated with at least one available shipment, the information associated with the at least one available shipment being input by a first freight carrier having a computer system connected to the central server;
receiving, at a central server, information associated with at least one available shipping container, the information associated with the at least one available shipping container being input by a second freight carrier having a computer system connected to the central server;
performing an automated association process at the central server, the automated association process including:
identifying a plurality of matching criteria to be met in determining an association;
assessing the at least one available shipment to identify characteristics of the shipment meeting the matching criteria;
assessing the at least one available shipping container to identify characteristics of the shipping container meeting the matching criteria;
associating the at least one available shipment with the at least one available shipping container based on the characteristics of the shipment and shipping container identified as meeting the matching criteria.

7. The one or more computer-readable media of claim 6, wherein the identified matching criteria include at least one of shipping container availability, shipment availability, shipment location, shipping container location, shipment destination and shipping container characteristics.

8. The one or more computer-readable media of claim 6, wherein the step of associating the at least one available shipment with the at least one available shipping container further including the step of outputting the associated shipment and shipping container.

9. The one or more computer-readable media of claim 6, wherein the step of associating the at least one available shipment with the at least one available shipping container further includes monitoring the shipment, subsequent to the automated association process, via the computer systems connected to the central server, wherein the monitoring is performed by the first freight carrier and the second freight carrier and wherein the step of monitoring is performed subsequent to the step of automatically associating.

10. The one or more computer-readable media of claim 9, wherein the step of monitoring further includes transmitting a status change.
